(19) United States
(12) Patent Application Publication
(10) Pub. No.: US 2024/0000072 A1
(43) Pub. Date: Jan. 4, 2024

(54) QUICK RELEASE INSECTICIDAL COMPOSITION

(71) Applicant: UPL Limited, Mumbai (IN)

(72) Inventors: Pravin Namadeo More, Mumbai (IN); Ankush Mali, Mumbai (IN); Popat Ganesh Chavan, Mumbai (IN); Pradeep Shamrao Sapkale, Mumbai (IN)

(21) Appl. No.: 18/039,231

(22) PCT Filed: Nov. 25, 2021
(86) PCT No.: PCT/IB2021/060954

§ 371 Date: May 27, 2023

(30) Foreign Application Priority Data
Nov. 27, 2020 (IN) 202021051797

(51) Int. Cl. A01N 25/26; A01N 25/08; A01N 43/56; A01P 7/04

(52) U.S. Cl. CPC A01N 25/26; A01N 25/08; A01N 43/56; A01P 7/04

(57) ABSTRACT

A quick release insecticidal composition is provided. Also provided is a process of preparing a quick release insecticidal composition. Methods of controlling pests comprising applying the quick release insecticidal composition to a pest or to a locus comprising the pest are also disclosed.

### FIELD OF THE DISCLOSURE

The present disclosure relates to a quick release insecticidal composition. The present disclosure additionally provides a process of preparing a quick release insecticidal composition and a method for controlling pests using the quick release insecticidal composition.

### BACKGROUND

Agrochemical active ingredients are used for controlling pests and diseases and for promoting plant growth in agriculture. Agrochemical formulations comprise active ingredients and inert ingredients. The “inert ingredients” do not possess biological activity, but are included in the formulation to obtain the desired dosage form such as granules, powder, suspension, or emulsion, or to impart desired characteristics such as binding, disintegration, and suspensibility.

In order to control pests or diseases and simultaneously promote plant growth, it is important that a sufficient amount of active ingredient(s) is available to the biological system. Too large of an amount of the active ingredient(s), however, is not desired because of environmental and economic concerns. Furthermore, greater amounts of the active ingredient(s) lead to increased risks of leaching to ground water or surface water. Meanwhile, too small of an amount of the active ingredient(s) results in a lack of pest control and increases the risk that the pest will develop resistance.

In granular formulations, active ingredients are formulated with inert ingredients such as binders, fillers, disintegrating agents, and/or surfactants, which are generally present in amounts greater than the amount of active ingredient(s). Often, active ingredients are not released to their full extent in the required time i.e., they are not released at the required rate and therefore do not achieve their intended performance.

Chlorantraniliprole, [3-bromo-N-[4-chloro-2-methyl-6-[(methyl amino) carbonyl] phenyl]-1-(3-chloro-2-pyridinyl)-1H-pyrazole-5-carboxamide], is an anthranilic diamide pesticide. Chlorantraniliprole is a poorly water-soluble compound, and thus developing a granular pesticide product that is readily available in a water-based system is difficult.

CN107873703 discloses granules containing chlorantraniliprole with other insecticide lambda-cyhalothrin.

WO201277961 discloses floating diffusible pesticide tablet formulations of agrochemically active ingredients for pest control.

CN102113516A discloses an insect killing compound containing chlorantraniliprole, which is prepared by two effective ingredients A and B. The ingredient A is chlorantraniliprole, the ingredient B is cypermethrin, trifluoro-cypermethrin, dursban, profenofos, dipterex, diafenthiuron, chlorfenapyr, emamectin benzoate, pleocidin, tebufenozide, hexaf lumuron, chlorfenapyr, pyridaben, acetamiprid, isoprocarb, dimehypo, or cartap, and the composed mass ratio of the effective ingredient A to the ingredient B is 1:60-60:1.

IN201821019166 discloses various combinations of chlorantraniliprole with other insecticidally active ingredients such as bifenthrin, lambda cyhalothrin, chlorpyrifos, cartap hydrochloride and thiocyclam hydrogen oxalate, along with other inactive ingredients to prepare various formulations such as granules (GR), water-dispersible granules (WDG), and ZC.

Although various compositions comprising chlorantraniliprole and/or its combination with other active ingredients have been developed, there remains a need to for granular formulations which can effectively deliver chlorantraniliprole and optional other active ingredients to plants/crops and improve their biological response in controlling insect populations.

### Objectives of the Disclosure

It is an objective of the present disclosure to provide a quick release composition comprising chlorantraniliprole.

It is another objective of the present disclosure to provide a quick release composition comprising chlorantraniliprole in the form of granules, such as broadcasting granules.

Yet another objective of the present disclosure is to provide a quick release composition comprising chlorantraniliprole in combination with an additional active ingredient such as an additional insecticide.

In another objective of the present disclosure, provided is a process of preparing a quick release composition comprising chlorantraniliprole and optionally at least one other active ingredient.

Still yet another objective of the present disclosure is to provide a method of controlling a pest using a quick release composition comprising chlorantraniliprole and optionally at least one other active ingredient.

### SUMMARY OF THE DISCLOSURE

It has surprisingly and unexpectedly been found that compositions containing a water insoluble insecticide such as chlorantraniliprole and a carrier matrix comprising a binder and a surfactant exhibit quick release of the insecticide and provides efficient control of pests.

In an aspect, the present disclosure provides a quick release insecticidal composition comprising:
at least one diamide insecticide; and
a carrier matrix comprising a binder and a surfactant,
wherein the diamide insecticide is dispersed in the carrier matrix.

In an aspect, the present disclosure provides a quick release insecticidal granule comprising:
at least one diamide insecticide;
a carrier matrix comprising a binder and a surfactant; and
a carrier granule;
wherein the diamide insecticide is dispersed in the carrier matrix, and
wherein at least one diamide insecticide and the carrier matrix comprising the binder and the surfactant are coated on the carrier granule.

In an aspect, a quick release insecticidal composition comprising:
at least one diamide insecticide; and
a carrier matrix comprising a binder and a surfactant; wherein the ratio of binder and surfactant is from about 1:5 to about 5:1,
wherein the diamide insecticide is dispersed in the carrier matrix.

In an aspect, the present disclosure provides a quick release insecticidal composition comprising:
at least one diamide insecticide;
at least one additional insecticide;
a carrier matrix comprising a binder and a surfactant; and
a carrier granule;
wherein the at least one diamide insecticide, the at least one additional insecticide, and the carrier matrix comprising the binder and the surfactant are coated on the carrier granule, and wherein the diamide insecticide and the additional insecticide are dispersed in the carrier matrix.

In an aspect, the present disclosure provides a quick release insecticidal composition comprising:
at least one diamide insecticide;
at least one additional insecticide; and
a carrier matrix comprising a binder and a surfactant;
wherein the ratio of binder and surfactant is from about 1:5 to about 5:1, and
wherein the diamide insecticide and the additional insecticide are dispersed in the carrier matrix.

In an aspect, the present disclosure provides a process of preparing a quick release insecticidal granule, comprising:
mixing at least one diamide insecticide and a carrier matrix comprising a binder and a surfactant to obtain a pre-mix;
coating the pre-mix on a carrier granule to obtain a coated granule; and
drying the coated granule to provide the quick release insecticidal granule.

In another aspect, the present disclosure provides a process of preparing a quick release insecticidal granule, comprising:
mixing at least one diamide insecticide and a carrier matrix comprising a binder and a surfactant to obtain a pre-mix, wherein the ratio of binder to surfactant is from about 1:5 to about 5:1;
coating the pre-mix on a carrier granule to obtain a coated granule; and
drying the coated granule to provide the quick release insecticidal granule.

In another aspect, the present disclosure provides a method of controlling pests, said method comprising applying of a composition to pests or to their locus, wherein the composition comprises:
at least one diamide insecticide;
a carrier matrix comprising a binder and a surfactant; and
a carrier granule,
wherein the diamide insecticide is dispersed in the carrier matrix.

### DETAILED DESCRIPTION OF THE DISCLOSURE

It has been surprisingly discovered that compositions comprising at least one diamide insecticide and a carrier matrix comprising a binder and a surfactant exhibit a quick release of chlorantraniliprole. It has also been found that the binder and the surfactant uniformly hold the dispersed diamide insecticide and readily release the diamide insecticide upon contact with water. The binder of the carrier matrix facilitates adhesion of the matrix to the carrier granule and holds the diamide insecticide within the matrix network. Further, and without being limited by theory, the surfactant facilitates uniform distribution of the diamide insecticide within the carrier matrix and facilitates its rapid dispersion upon contact with water. The rapid dispersion ultimately enables quick release of diamide insecticide.

In an aspect, the quick release insecticidal composition of the present disclosure is in granular form, which can be applied, for example, with a dry spreader or by hand to a target area. The quick release insecticidal composition can be applied either with or without a secondary carrier such as a fertilizer or dry soil, and upon contact with water, for example rain or irrigation, the insecticide material is released from the carrier matrix. In an aspect, the granules of the present disclosure are coated with the insecticide material dispersed in a matric comprising a binder, and surfactant, and the binder and surfactant disintegrate readily upon contact with water and spread quickly for imparting its insecticidal action.

As used herein, the term “pest” refers to an organism, and in particular an insect, which is detrimental to the growth, reproduction, and/or viability of a plant, a portion of the plant or a plant seed.

The term “control” as it relates to a pest, includes the killing of the pest, as well as protecting a plant, a portion of the plant, or a plant seed from attack or invasion by said pest.

As used throughout the disclosure, the term “quick release” as it relates to an insecticidal composition refers to the release of at least 60%, or at least 65%, or at least 70%, or at least 75% release of active diamide insecticide to a crop in less than or equal to 1 hour, preferably, less than or equal to 30 minutes.

As used throughout the disclosure, the term “release rate” refers to the percentage of active ingredient released from the carrier granule per unit time.

As used throughout the disclosure, “carrier matrix” is used to refer to a mixture of a binder and a surfactant.

As used throughout the disclosure, “carrier granule” refers to a granule on which a carrier matrix comprising an active ingredient is coated.

As used throughout the disclosure, “coated granule” refers to a carrier granule coated with the carrier matrix comprising an active ingredient.

As used throughout the disclosure, an “insecticidal composition” refers to a composition having insecticidal, acaricidal, molluscicidal and/or nematicidal properties, i.e., that is capable of killing and/or controlling growth of an insect pest.

As used throughout the disclosure, the term “binder” includes, but is not limited to, a polymeric binder.

As used throughout the disclosure, the diamide insecticide or other active ingredients, include their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods. A “solvate” means the insecticide or its pharmaceutically acceptable salt, wherein molecules of a suitable solvent are incorporated in the crystal lattice. A suitable solvent is physiologically tolerable at the dosage administered. Examples of suitable solvents are ethanol, water and the like. When water is the solvent, the molecule is referred to as a “hydrate”. The formation of solvates will vary depending on the compound and the solvate. In general, solvates are formed by dissolving the compound in the appropriate solvent and isolating the solvate by cooling or using an antisolvent. The solvate is typically dried or azeotroped under ambient conditions. In an aspect, the solvate is a hydrate.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable.

The use of the terms “a” and “an” and “the” and similar referents (especially in the context of the following claims) are to be construed to cover both the singular and the plural, unless otherwise indicated herein or clearly contradicted by context.

Accordingly, in an aspect of the present disclosure, a quick release insecticidal composition comprises:
at least one diamide insecticide; and
a carrier matrix comprising a binder and a surfactant, wherein the diamide insecticide is dispersed in the carrier matrix.

According to an aspect of the present disclosure, the diamide insecticide comprises afoxolaner, broflanilide, chlorantraniliprole, cyantraniliprole, cyclaniliprole, cyhalodiamide, flubendiamide, fluralaner, lotilaner, tetrachlorantraniliprole, tetraniliprole, or a combination thereof.

According to another preferred aspect of the present disclosure, the diamide insecticide is chlorantraniliprole.

According to another preferred aspect of the present disclosure, the diamide insecticide is cyantraniliprole.

The quick release insecticidal composition comprises from about 0.1% w/w to about 70% w/w, or 0.1% w/w to about 60% w/w, or about 0.1% w/w to about 50% w/w, or about 0.1% w/w to about 40% w/w, or about 0.1% w/w to about 30% w/w, or about 0.1% w/w to about 25% w/w, or about 0.1% w/w to about 15% w/w, or about 0.1% w/w to about 10% w/w, or about 0.1% w/w to about 5% w/w of the diamide insecticide based on the total weight of the composition including the carrier granule.

According to an aspect of the present disclosure, a quick release insecticidal composition comprises from about 0.1% w/w to about 40% w/w, or about 0.5% w/w to about 35% w/w, or about 1% w/w to about 30% w/w, or about 1% w/w to about 20% w/w of the carrier matrix based on the total weight of the composition.

According to an aspect of the present disclosure, the carrier matrix of quick release insecticidal composition comprises a binder and a surfactant.

According to an aspect of the present disclosure, the binder in the carrier matrix of quick release insecticidal composition is a water-soluble binder, a water-swellable binder, or a combination thereof.

According to an aspect of the present disclosure, the water-soluble binder comprises polyvinyl pyrrolidone, polyethylene glycol, polyethylene oxide, polyethoxylated fatty acids, polyethoxylated alcohols, natural gums, lignosulphonate, or a combination thereof.

According to an aspect of the present disclosure, the water swellable binder of comprises china clay, bentonite, Fuller's earth, zeolite, quartz, precipitated silica, palygorskite, sepiolite, halloysite, or a combination thereof.

According to an aspect of the present disclosure, a quick release insecticidal composition comprises from about 0.01% w/w to about 30% w/w, or about 0.1% w/w to about 25% w/w, or about 0.5% w/w to about 20% w/w, or about 1% w/w to about 10% w/w of the binder based on the total weight of the composition including the carrier granule.

According to an aspect of the present disclosure, the quick release insecticidal composition comprises carrier granules.

According to an aspect of the present disclosure, the carrier granules of are composed of a chemically inert material and have a surface on which the carrier matrix is coated.

According to an aspect of the present disclosure, the carrier granules comprise sand, silica, bentonite, attapulgite, ceramic, montmorillonite, pumice, sepiolite, diatomaceous earth, clay, dolomite, calcite, or a combination thereof.

According to an aspect of the present disclosure, the carrier matrix of quick release insecticidal composition comprises a surfactant.

According to an aspect of the present disclosure, the surfactant comprises an anionic surfactant, a cationic surfactant, a non-ionic surfactant, an amphoteric surfactant, or a combination thereof.

According to an aspect of the present disclosure, the anionic surfactant comprises a substituted or unsubstituted polymeric alkyl aryl sulfonate, or a salt thereof. In an aspect, the anionic surfactant comprises sodium (C₁-C₁₀) alkylnaphthalene sulfonate, sodium naphthalene sulfonate, calcium lignosulfonate, sodium lignosulfonate, ammonium lignosulfonate, or a combination thereof.

According to an aspect of the present disclosure, the non-ionic surfactant comprises alcohol ethoxylates, tallow amine ethoxylates, ethylene oxide-propylene oxide-ethylene oxide (EO-PO-EO) block copolymers having a weight average molecular weight of 1000 to 5000 Da, a sodium salt of an acid resin copolymer, sodium-N-methyl-N-oleyl taurate, sodium polycarboxylate, modified styrene acrylic polymer, or a combination thereof.

According to an aspect of the present disclosure, the quick release insecticidal composition comprises from about 0.01% w/w to about 30% w/w, or about 0.1% w/w to about 25% w/w, or about 0.5% w/w to about 20% w/w, or about 0.5% w/w to about 10% w/w of surfactant based on the total weight of quick release insecticidal composition including the carrier granule.

According to an aspect of the present disclosure, a quick release insecticidal composition comprises:
at least one diamide insecticide;
a carrier matrix comprising a binder and a surfactant; and
a carrier granule;
wherein the diamide insecticide and the carrier matrix are coated on the carrier granule, and wherein the diamide insecticide is dispersed in the carrier matrix.

According to an aspect of the present disclosure, the diamide insecticide is held (adhered) on the surface of the carrier granule.

According to an aspect of the present disclosure, a quick release insecticidal composition comprises:
at least one diamide insecticide; and
a carrier matrix comprising a binder and a surfactant,
wherein the ratio of binder and surfactant is from about 1:5 to about 5:1; and
wherein the diamide insecticide is dispersed in the carrier matrix.

According to an aspect of the present disclosure, a quick release insecticidal composition comprises:
at least one diamide insecticide,
a carrier matrix comprising a binder and a surfactant, and
a carrier granule;
wherein the ratio of binder and surfactant is from about 1:5 to about 5:1; and
wherein the diamide insecticide is dispersed in the carrier matrix.

According to an aspect of the present disclosure, the quick release insecticidal composition is obtained by coating the diamide insecticide and the carrier matrix mixture on the surface of the carrier granule.

According to an aspect of the present disclosure, the weight the ratio of the binder to the surfactant in the carrier matrix is from about 1:5 to about 5:1.

According to an aspect of the present disclosure, the weight the ratio of binder to surfactant in the carrier matrix is from about 1:3 to about 3:1.

According to an aspect of the present disclosure, the ratio of binder to surfactant in the carrier matrix is about 1:2.

According to an aspect of the present disclosure, the ratio of binder to surfactant in the carrier matrix is about 1:1.5.

According to an aspect of the present disclosure, the ratio of binder to surfactant in the carrier matrix is in about 1:1.

According to an aspect of the present disclosure, in addition to the diamide insecticide, the quick release insecticidal composition further comprises an additional insecticide. The additional insecticide can be combined together with the diamide insecticide and the carrier matrix and applied on the surface of the carrier granule. Alternatively, the diamide insecticide and the additional insecticide can be separately combined with the carrier matrix and separately applied on the carrier granule.

According to an aspect of the present disclosure, the quick release insecticidal composition comprises chlorantraniliprole and at least one additional insecticide.

According to an aspect of the present disclosure, the at least one additional insecticide comprises a benzoylphenyl urea group insecticide, a phenyl pyrazole group insecticide, a nereistoxin analogue group insecticide, a diacylhydrazine group insecticide, a pyrethroid group insecticide, a neonicotinoid group insecticide, or a combination thereof.

According to an aspect of the present disclosure, the benzoylphenyl urea group insecticide comprises bistrifluron, chlorbenzuron, chlorfluazuron, dichlorbenzuron, diflubenzuron, flucycloxuron, flufenoxuron, hexaflumuron, lufenuron, novaluron, noviflumuron, penfluron, teflubenzuron, triflumuron, or a combination thereof.

According to an aspect of the present disclosure, the phenyl pyrazole group insecticide comprises acetoprole, fipronil, ethiprole, vaniliprole, or a combination thereof.

According to an aspect of the present disclosure, the nereistoxin analogue group insecticide comprises bensultap, cartap, polythialan, thiocyclam, thiosultap, or a combination thereof.

According to an aspect of the present disclosure, the diacylhydrazine group insecticide comprises chromafenozide, furan tebufenozide, halofenozide, methoxyfenozide, or a combination thereof.

According to preferred aspect of the present disclosure, the diacylhydrazine group insecticide comprises chromafenozide, methoxyfenozide, or a combination thereof.

According to an aspect of the present disclosure, the neonicotinoid group insecticide of comprises clothianidin, dinotefuran, imidacloprid, imidaclothiz, thiamethoxam, nitenpyram, nithiazine, acetamiprid, cycloxaprid, thiacloprid, or a combination thereof.

According to preferred aspect of the present disclosure, the neonicotinoid group insecticide comprises clothianidin, imidacloprid, acetamiprid, thiamethoxam, thiacloprid, or a combination thereof.

According to an aspect of the present disclosure, the pyrrole group insecticide comprises chlorfenapyr.

According to preferred aspect of the present disclosure, the pyrethroid group insecticide comprises bifenthrin, cypermethrin, lambda-cyhalothrin, or a combination thereof.

According to an aspect of the present disclosure, the quick release insecticidal composition comprises the additional insecticide in an amount from about 0.1% w/w to about 70% w/w, or about 0.1% w/w to about 60% w/w, or about w/w to about 60% w/w, or about 0.1% w/w to about 50% w/w, or about 0.1% w/w to about 40% w/w, or about 0.1% w/w to about 30% w/w, or about 0.1% w/w to about 20% w/w, based on the total weight of the composition including the carrier granule.

In an aspect of the present disclosure, the quick release insecticidal composition further comprises antifreeze agents, wetting agents, fillers, surfactants, anticaking agents, pH-regulating agents, preservatives, biocides, antifoaming agents, colorants, other formulation aids or inactive ingredients, or a combination thereof.

According to an aspect of the present disclosure, the quick release insecticidal composition comprises a diamide insecticide and a carrier matrix, wherein said insecticidal composition is in the form of a granular composition.

According to an aspect of the present disclosure, the quick release insecticidal composition comprises from about 0.1% w/w to about 70% w/w diamide insecticide and from about 1% w/w to about 30% w/w carrier matrix based on the total weight of the composition including the carrier granule.

According to an aspect of the present disclosure, the quick release insecticidal composition comprises from about 0.1% w/w to about 60% w/w and from about 0.5% w/w to about 35% w/w carrier matrix based on the total weight of the composition.

According to an aspect of the present disclosure, the quick release insecticidal composition comprises from about 0.1% w/w to about 50% w/w diamide insecticide and from about 1% w/w to about 30% w/w carrier matrix based on the total weight of the composition.

According to an aspect of the present disclosure, the quick release insecticidal composition comprises from about 0.1% w/w to about 70% w/w diamide insecticide, from about 0.01 w/w % to about 30% w/w binder, and from about 0.01% w/w to about 30% w/w surfactant based on the total weight of the composition including the carrier granule.

According to an aspect of the present disclosure, the quick release insecticidal composition comprises from about 0.1% w/w to about 60% w/w diamide insecticide, from about 0.1% w/w to about 25% w/w binder, and from about 0.1% w/w to about 25% w/w surfactant based on the total weight of the composition including the carrier granule.

According to an aspect of the present disclosure, the quick release insecticidal composition comprises from about 0.1% w/w to about 50% w/w diamide insecticide, from about 0.5% w/w to about 20% w/w binder, and from about 0.5% w/w to about 20% w/w surfactant based on the total weight of the composition including the carrier granule.

According to an aspect of the present disclosure, the quick release insecticidal composition comprises from about 0.1% w/w to about 70% w/w diamide insecticide, from about 0.01% w/w to about 30% w/w binder, from about w/w to about 30% w/w surfactant, and from about 0.1% w/w to about 70% w/w of an additional insecticide based on the total weight of the composition including the carrier granule.

According to an aspect of the present disclosure, the quick release insecticidal composition comprises from about 0.1% w/w to about 60% diamide insecticide, from about 0.1% w/w to about 25% w/w binder, from about 0.1% w/w to about 25% w/w surfactant and from about 0.1% w/w to about 60% w/w of an additional insecticide based on the total weight of the composition including the carrier granule.

According to an aspect of the present disclosure, the quick release insecticidal composition comprises from about 0.1% w/w to about 50% w/w diamide insecticide, from about 0.5% w/w to about 20% w/w binder, from about w/w to about 20% w/w surfactant and from about 0.1% w/w to about 50% w/w of an additional insecticide based on the total weight of the composition including the carrier granule wherein binder and surfactant are in from about 1:5 ratio. In an aspect, the weight ratio of binder to surfactant is 5:1. In aspect, the composition is in the form of broadcasting granules.

According to an aspect of the present disclosure, the rate of release of the diamide insecticide from the carrier granules is from about 60% to about 100%, or about 70% to about 100%, or about 80% to about 100%, or about 90% to about 100%, or about 95% to about 100%, or about 99% to about 100% in less than or equal to 1 hour.

According to an aspect of the present disclosure, the rate of release of the diamide insecticide from carrier granules is greater than or equal to 60%, 65%, 70%, 75%, 80%, 85%, 90%, 95%, or 99%, in less than or equal to 1 hour.

According to an aspect of the present disclosure, rate of release of diamide insecticide from carrier granules is greater than 70% in less than or equal to about 1 hour.

According to an aspect of the present disclosure, rate of release of diamide insecticide from carrier granules is greater than 80% in less than or equal to about 1 hour.

According to an aspect of the present disclosure, rate of release of diamide insecticide from carrier granules is greater than or equal to 60%, 65%, 70%, 75%, 80%, 85%, or 90%, in less than or equal to about 30 minutes.

According to an aspect of the present disclosure, rate of release of diamide insecticide from carrier granules is greater than 70% in 30 minutes.

According to an aspect of the present disclosure, rate of release of diamide insecticide from carrier granules is greater than 80% in 30 minutes.

According to an aspect of the present disclosure, rate of release of diamide insecticide from carrier granules is greater than or equal to 60%, 65%, 70%, 75%, 80%, 85%, or 90%, in less than or equal to about 10 minutes.

According to an aspect of the present disclosure, rate of release of diamide insecticide from carrier granules is greater than 70% in 10 minutes.

According to an aspect of the present disclosure, rate of release of diamide insecticide from carrier granules is greater than 80% in 10 minutes.

According to an aspect of the present disclosure, rate of release of diamide insecticide from carrier granules is greater than 85% in 10 minutes.

According to an aspect of the present disclosure, granules while not being limited to any particular sizes, they typically have an average particle size in the range of about 0.1 to about 10 mm, preferably between about 0.25 to about 5 mm, and more preferably between about 0.5 to about 3 mm, although granules with sizes outside of these ranges also fall within the scope of the present invention.

According to an aspect of the present disclosure, provided is a process of preparing a quick release insecticidal granule, comprising:
mixing at least one diamide insecticide and a carrier matrix comprising a binder and a surfactant to obtain a pre-mix;
coating the pre-mix on a carrier granule to obtain a coated granule; and
drying the coated granule to obtain the quick release insecticidal granule. In an aspect, the quick release insecticidal granule comprises: (a) at least one diamide insecticide; and (b) the carrier matrix comprising the binder and the surfactant.

According to an aspect of the present disclosure, provided is a process of preparing a quick release insecticidal granule, comprising:
mixing at least one diamide insecticide, an additional insecticide, and a carrier matrix comprising a binder and a surfactant to obtain a pre-mix, wherein the diamide insecticide and the additional insecticide are milled prior to the mixing;
coating the pre-mix on a carrier granule to obtain a coated granule; and
drying the coated granule to obtain the quick release insecticidal granule.

In an aspect, the quick release insecticidal granule comprises: the at least one diamide insecticide, the additional insecticide, and the carrier matrix comprising the binder and the surfactant.

According to an aspect of the present disclosure, a carrier matrix comprising a binder and a surfactant is dissolved in water to obtain a solution which is then coated on the carrier granules.

According to an aspect of the present disclosure, the weight ratio of binder to surfactant in the carrier matrix is from about 1:5 to about 5:1.

According to an aspect of the present disclosure, provided is a process of preparing quick release insecticidal granules, comprising:
mixing at least one diamide insecticide, at least one additional insecticide, and a carrier matrix comprising a binder and a surfactant to obtain pre-mix;
coating the pre-mix on sand granules to obtain coated granules; and
drying the coated granules to obtain quick release granules.

In an aspect, the weight ratio of the binder to the surfactant is from about 1:5 to about 5:1.

According to an aspect, the present disclosure provides a method of controlling pests comprising applying a quick release insecticidal composition to the pests or to a locus comprising the pests, wherein the quick release insecticidal composition comprises:
at least one diamide insecticide; and
a carrier matrix comprising a binder and a surfactant.

According to an aspect, the present disclosure provides a method of controlling pests comprising applying a quick release insecticidal composition to the pests or to a locus comprising the pests, wherein the composition comprises:
at least one diamide insecticide;
a carrier matrix comprising a binder and a surfactant; and
a carrier granule.

According to an aspect, the carrier matrix comprises the binder and the surfactant in a weight ratio of from about 1:5 to about 5:1.

According to an aspect, the present disclosure provides a method of controlling pests comprising applying a quick release insecticidal composition to pests or to a locus comprising the pests, wherein the composition comprises:
at least one diamide insecticide;
at least one additional insecticide; and
a carrier matrix comprising a binder and a surfactant.

According to an aspect, the present disclosure provides a method of controlling pests, said method comprising applying a quick release insecticidal composition to pests or to their locus, wherein the composition comprises: at least one diamide insecticide;
at least one additional insecticide;
a carrier matrix comprising a binder and a surfactant; and
a carrier granule.

According to an aspect, the quick release insecticidal composition is used to control a wide range of pests.

In an aspect, the insect pests controlled by the quick release composition of the present disclosure is from the class Insecta, Arachnida or Nematoda.

Exemplary pests include:
from the order Lepidoptera, such as Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni, and Yponomeuta spp.;
from the order Coleoptera, pest such as Agriotes spp., Anthonomus spp., Atomaria linearis, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Tenebrio spp., Tribolium spp., and Trogoderma spp.;
from the order Orthoptera, pests such as Blatta spp., Blattella spp., Gryllotalpa spp., Leucophaea maderae, Locusta spp., Periplaneta spp. and Schistocerca spp.;
from the order Isoptera, pests such as Reticulitermes spp.;
from the order Psocoptera pest such as, Liposcelis spp.;
from the order Anoplura, pests such as Haematopinus spp., Linognathus spp., Pediculus spp., Pemphigus spp. And Phylloxera spp.;
from the order Mallophaga pests such as Damalinea spp. And Trichodectes spp.;
from the order Thysanoptera, pests such as Frankliniella spp., Hercinothrips spp., Taeniothrips spp., Thrips palmi, Thrips tabaci, and Scirtothrips aurantii;
from the order Heteroptera, pests such as Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp., and Triatoma spp.;
from the order Homoptera, insect pests such as Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae, and Unaspis citri;
from the order Hymenoptera, insect pests such as Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp., and Vespa spp.;
from the order Diptera, insect pests such as Antherigona soccata, Bibio hortulanus, Ceratitis spp., Chrysomyia spp., Culex spp., Cuterebra spp., Dacus spp., Delia spp., Drosophila melanogaster, Liriomyza spp., Melanagromyza spp., Orseolia spp., Oscinella frit, Pegomyia hyoscyami, Phorbia spp., Rhagoletis pomonella, and Sciara spp.;
from the order Acarina, pests such as Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta spp. (such as Phyllocoptruta oleivora), Polyphagotarsonemus latus, Psoroptes spp., Rhipicephalus spp., Rhizoglyphus spp., Sarcoptes spp., Tarsonemus spp., and Tetranychus spp.; and
from the class Nematoda, the species of Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp., Belonlaimus spp., Criconemella spp., Criconemoides spp., Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

Euschistus heros (stink bug), belonging to neotropical species is widespread throughout South America, which can cause serious damage to several host plants such as soybean, beans, cotton, sunflower and other plant species and its control is important and challenging due to the limited number of registered, effective mode of actions (active ingredients chemical groups/sub-groups) to control such target insect and due to the capability of Euschistus heros to develop resistance to several active ingredients.

According to an aspect of the present disclosure, the quick release insecticidal composition retains its physical integrity during handling and spreading, and upon broadcasting, releases the active ingredients upon contact with wet soil, irrigation water, or rainfall.

According to an aspect of the present disclosure, the quick release insecticidal composition is provided as a component of a kit.

According to an aspect of the present disclosure, the kit of quick release insecticidal composition comprises a plurality of components, each of which components may include at least one, or more, of the ingredients of the quick release insecticidal composition.

### EXAMPLES

### Example 1: Chlorantraniliprole 8.33+Fipronil 13.33 g/kg GR

The materials in Table 1 were used to prepare the insecticide composition of Example 1.

TABLE 1

| Ingredients | Quantity (g/Kg) |
|---|---|
| Chlorantraniliprole | 9.10 |
| Fipronil | 14.57 |
| Sodium lignosulphonate | 30.00 |
| Sodium diisopropyl naphthalene sulfonate | 2.00 |
| Polyvinylpyrrolidone | 3.00 |
| Kaolin | 142.00 |
| Citric acid | 1.70 |
| Sand granules | 797.63 |
| Total | 1000.00 |

9.10 g chlorantraniliprole and 14.57 g fipronil were charged into a mixing vessel. Separately, a solution was prepared by mixing 30 g sodium lignosulphonate, 2 g sodium diisopropyl naphthalene sulfonate and 3 g polyvinylpyrrolidone in water. The solution was then charged into the mixing vessel and the contents were homogenized to obtain a pre-mix. To the pre-mix, 142 g kaolin and 1.7 g citric acid were added. To coat the pre-mix on carrier granules, 797.63 g sand granules were charged into the mixing vessel under continuous homogenization for about 30 min to obtain coated sand granules. The mixture of coated sand granules was then allowed to dry to obtain a quick release insecticidal composition.

### Example 2: Chlorantraniliprole 0.40%+Cartap 7.50% w/w GR

The materials in Table 2 were used to prepare the insecticide composition of Example 2.

TABLE 2

| Ingredients | Quantity (% w/w) |
|---|---|
| Chlorantraniliprole | 0.45 |
| Cartap Hydrochloride | 8.21 |
| Phosphoric Acid | 0.35 |
| Isopropyl acid Phosphate | 1.5 |
| Nonylphenol ethoxylate | 2.5 |
| Blank granules (River Sand) | 82.99 |
| China Clay | 4 |
| Total | 100 |

0.45 g chlorantraniliprole and 8.21 g cartap hydrochloride were charged into a mixing vessel. 0.35 g phosphoric acid and 4 g china clay were charged into the same mixing vessel and homogenized to obtain a pre-mix. Separately, 1.5 g isopropyl acid phosphate and 2.5 g nonylphenol ethoxylate were dissolved in water to obtain a solution. To coat the pre-mix on carrier granules, 82.99 g carrier granules (river sand) were charged in the mixing vessel and the separately prepared solution was slowly added under continuous homogenization to the same mixing vessel for about 30 min, to obtain coated granules. The coated granules were then allowed to dry to obtain a quick release insecticidal composition.

### Example 3: Chlorantraniliprole 0.5% w/w+Flupyrimin 1.0% w/w GR

The materials in Table 3 were used to prepare the insecticide composition of Example 3.

TABLE 3

| Ingredients | Quantity (% w/w) |
|---|---|
| Chlorantraniliprole tech | 0.54 |
| Flupyrimin | 1.12 |
| Polyvinyl pyrrolidone (PVP K-30) | 0.3 |
| Sodium diisopropylene naphthalene sulfonate | 0.5 |
| Kaolin | 1.0 |
| Diethylene Glycol | 0.5 |
| Silica granules | QS |
| Total | 100 |

0.54 g chlorantraniliprole and 1.12 g flupyrimin were charged into a mixing vessel. 0.5 g diethylene glycol was charged into the same mixing vessel and homogenized. Separately, a solution was prepared by adding 0.5 g sodium diisopropyl naphthalene sulfonate and 0.3 g polyvinylpyrrolidone in water. The solution was added to the same mixing vessel to obtain a pre-mix. To the pre-mix, 1 g kaolin was added. To coat the pre-mix on carrier granules, silica granules were charged into the mixing vessel under continuous homogenization for about 30 min to obtain coated granules. The coated granules were then allowed to dry to obtain a quick release insecticidal composition.

### Example 4: Chlorantraniliprole 0.4+Fipronil 0.4% w/w GR

The materials in Table 4 were used to prepare the insecticide composition of Example 4.

TABLE 4

| Ingredients | Quantity (% w/w) |
|---|---|
| Chlorantraniliprole | 0.44 |
| Fipronil | 0.44 |
| Sodium lignosulphonate | 3.00 |
| Sodium diisopropyl naphthalene sulfonate | 0.20 |
| Polyvinylpyrrolidone | 0.30 |
| Kaolin | 14.20 |
| Citric acid | 0.17 |
| Sand granules | 81.25 |
| Total | 100.00 |

0.44 g chlorantraniliprole and 0.44 g fipronil were charged into a mixing vessel. Separately, a solution was prepared by mixing 3 g sodium lignosulphonate, 0.2 g sodium diisopropyl naphthalene sulfonate and 0.3 g polyvinylpyrrolidone in water. The solution was charged in the same mixing vessel and homogenized to obtain a pre-mix. To the pre-mix, 14.02 g kaolin, 0.17 g citric acid were added. To coat the pre-mix on carrier granules, 81.25 g sand granules were then charged in the mixing vessel under continuous homogenization for about 30 min to obtain coated sand granules. The coated granules were then allowed to dry to obtain a quick release insecticidal composition.

### Example 5: Chlorantraniliprole 0.90%+Novaluron 0.40% w/w GR

The materials in Table 5 were used to prepare the insecticide composition of Example 5.

TABLE 5

| Ingredients | Quantity (% w/w) |
|---|---|
| Chlorantraniliprole | 0.95 |
| Novaluron | 0.43 |
| Polyvinyl pyrrolidone | 0.3 |
| Sodium diisopropylene naphthalene sulfonate | 0.5 |
| Brilliant blue | 0.05 |
| Kaolin | 1 |
| Diethylene Glycol | 0.5 |
| Silica granules | QS |
| Total | 100 |

0.95 g chlorantraniliprole and 0.43 g novaluron were charged into mixing vessel. 0.5 g diethylene glycol was charged into the same mixing vessel and homogenized. Separately, a solution was prepared by adding 0.5 g sodium diisopropyl naphthalene sulfonate, 0.3 g polyvinylpyrrolidone, and 0.05 g brilliant blue dye to water. The solution was added to the same mixing vessel to obtain the pre-mix. To the pre-mix, 1 g kaolin was added. To coat the pre-mix on carrier granules, 96.27 g silica granules were charged in the mixing vessel under continuous homogenization for about 30 min to obtain coated granules. The coated granules were then allowed to dry to obtain a quick release insecticidal composition.

### Example 6: Chlorantraniliprole 0.4% w/w GR

The materials in Table 6 were used to prepare the insecticide composition of Example 6.

TABLE 6

| Ingredients | Quantity (% w/w) |
|---|---|
| Chlorantraniliprole | 0.45 |
| Polyvinyl alcohol | 0.5 |
| Isotridecanol ethoxylate (Sterol 1309) | 0.4 |
| Calcium lignosulphonate | 1.0 |
| Pigment dye | 0.05 |
| Talc | 6 |
| River sand granules | 91.6 |
| Total | 100 |

0.45 g chlorantraniliprole was charged into a mixing vessel. 0.5 g polyvinyl alcohol was charged into the same mixing vessel and homogenized to obtain pre-mix. Separately, 1.5 g calcium lignosulphonate and 0.4 g isotridecanol ethoxylate were dissolved in water to obtain solution. To coat the pre-mix on granules, 91.6 g of carrier river sand granules were charged in the mixing vessel and the separately prepared solution was slowly added under continuous homogenization to the same mixing vessel for about 30 min to obtain coated granules. The coated granules were then allowed to obtain a quick release insecticidal composition.

### Example 7: Chlorantraniliprole 0.5%+Flupyrimin 1.0% GR

The materials in Table 7 were used to prepare the insecticide composition of Example 7.

TABLE 7

| Ingredients | Quantity (% w/w) |
|---|---|
| Chlorantraniliprole | 0.56 |
| Flupyrimin | 1.12 |
| River sand granules | 95.12 |
| Polyvinylpyrrolidone | 0.30 |
| Sodium isopropyl naphthalene sulfonate | 0.50 |
| Zinc EDTA | 0.90 |
| Diethylene glycol | 0.50 |
| Kaolin | Qs |
| Total | 100 |

Chlorantraniliprole, flupyrimin, the river sand granules, polyvinylpyrrolidone, sodium isopropyl naphthalene sulfonate, zinc EDTA, diethylene glycol and kaolin were mixed in above given quantity and quick release insecticidal composition was prepared according to process of Example-3.

### Example 8: Chlorantraniliprole 0.5%+Flupyrimin 1% GR

The materials in Table 8 were used to prepare the insecticide composition of Example 8.

TABLE 8

| Ingredients | Quantity (% w/w) |
|---|---|
| Chlorantraniliprole | 0.56 |
| Flupyrimin | 1.12 |
| River sand granules | 91.02 |
| Polyvinylpyrrolidone | 0.30 |
| Sodium isopropyl naphthalene sulfonate | 0.50 |
| Zinc EDTA | 5.0 |
| Diethylene glycol | 0.50 |
| Kaolin | Qs |
| Total | 100 |

Chlorantraniliprole, flupyrimin, river sand granules, polyvinylpyrrolidone, sodium isopropyl naphthalene sulfonate, zinc EDTA, diethylene glycol, and kaolin were mixed in quantities shown in Table 8 and a quick release insecticidal composition was prepared as described in Example 3.

### Example 9: Chlorantraniliprole 0.5%+Flupyrimin 1.0% GR

The materials in Table 9 were used to prepare the insecticide composition of Example 9.

TABLE 9

| Ingredients | Quantity (% w/w) |
|---|---|
| Chlorantraniliprole | 0.56 |
| Flupyrimin | 1.12 |
| River sand | 86.02 |
| Polyvinylpyrrolidone | 0.30 |
| Sodium isopropyl naphthalene sulfonate | 0.50 |
| Zinc EDTA | 10.0 |
| Diethylene glycol | 0.50 |
| Kaolin | 1.00 |
| Total | 100.0 |

Chlorantraniliprole, flupyrimin, river sand granules, polyvinylpyrrolidone, sodium isopropyl naphthalene sulfonate, zinc EDTA, diethylene glycol and kaolin were mixed in the quantities shown in Table 9, and a quick release insecticidal composition was prepared as described in Example 3.

### Example 10: Chlorantraniliprole 0.4%+Flupyrimin 1.0% GR

The materials in Table 10 were used to prepare the insecticide composition of Example 10.

TABLE 10

| Ingredients | Quantity (% w/w) |
|---|---|
| Chlorantraniliprole | 0.443 |
| Flupyrimin | 1.12 |
| River sand granules | 96.13 |
| Polyvinylpyrrolidone | 0.30 |
| Sodium isopropyl naphthalene sulfonate | 0.50 |
| Diethylene glycol | 0.50 |
| Kaolin | 1.00 |
| Total | 100.0 |

Chlorantraniliprole, flupyrimin, river sand granules, polyvinylpyrrolidone, sodium isopropyl naphthalene sulfonate, zinc EDTA, diethylene glycol, and kaolin were mixed in the quantities shown in Table 10 and a quick release insecticidal composition was prepared as described in Example 3.

### Example 11: Chlorantraniliprole 0.4%+Flupyrimin 1.0% GR

The materials in Table 11 were used to prepare the insecticide composition of Example 11.

TABLE 11

| Ingredients | Quantity (% w/w) |
|---|---|
| Chlorantraniliprole | 0.443 |
| Flupyrimin | 1.12 |
| River sand granules | 86.13 |
| Polyvinylyrrolidone | 0.30 |
| Sodium isopropyl naphthalene sulfonate | 0.50 |
| Zinc EDTA | 10.00 |
| Diethylene glycol | 0.50 |
| Kaolin | 1.00 |
| Total | 100.0 |

Chlorantraniliprole, flupyrimin, river sand granules, polyvinylpyrrolidone, sodium isopropyl naphthalene sulfonate, zinc EDTA, diethylene glycol, and kaolin were mixed in the quantities shown in Table 11 and a quick release insecticidal composition was prepared as described in Example 3.

### Example 12: Chlorantraniliprole 0.4% GR

The materials in Table 12 were used to prepare the insecticide composition of Example 12.

TABLE 12

| Ingredient | % w/w |
|---|---|
| Chlorantraniliprole | 0.47 |
| Calcium lignosulphonate | 1.0 |
| Dye | 0.05 |
| Alcohol Alkoxylate | 0.4 |
| Polyvinyl Alcohol | 0.5 |
| Silicon dioxide (quartz) | q.s. |
| Total | 100 |

Chlorantraniliprole, calcium lignosulfonate, dye, alcohol alkoxylate, polyvinyl alcohol, and silicon dioxide were mixed in the quantities shown in Table 12 and a quick release insecticidal composition was prepared as described in Example 3.

### Stability Study of Quick Release Compositions

The compositions of Examples 1-12 were evaluated for various parameters in order to ascertain the stability of the quick release insecticidal compositions. Stability parameters were evaluated under ambient conditions (0 days) and under accelerated heat stability (AHS, 14 days) conditions (at a temperature of 54° C.). It was found that the activity of chlorantraniliprole and the additional agrochemical ingredients, measured by the amount of active compound remaining under ambient and AHS conditions, remained quite stable. The particle sizes of Example 1, 2, and 4-6 were determined by passing the compositions through a 12 BSS sieve and a 36 BSS sieve. About 99% of the particles passed through the 12 BSS sieve and the remaining 1% or less passed through the 36 BSS sieve, resulting in quick release insecticidal compositions with uniform particle size. The pH of the compositions of Example 1-12 also remained within acceptable limits. The results are shown in Tables 13 to 23 below.

TABLE 13
Example-1

| Test Parameters | 0 day Results | 14 Days 54° C. AHS |
|---|---|---|
| Appearance | Light brown to brown | Light brown to brown |
| | flowing granules, free | flowing granules, free |
| | from extraneous matter | from extraneous matter |
| Chlorantraniliprole | 8.19 | 8.05 |
| content | | |
| Fipronil content | 13.31 | 13.11 |
| pH (1% Aq. Dispersion)* | 7.6 | 7.59 |
| Moisture (% w/w) | 0.78 | 0.85 |
| Particles pass through | 99.3 | 99.4 |
| sieve of 12 BSS | | |
| Particles pass through | 0.7 | 0.6 |
| sieve of 36 BSS | | |

TABLE 14

| | | |
|---|---|---|
| Test Parameters | 0 day Results | 14 Days 54° C. AHS |

Example-2

| | | |
|---|---|---|
| Appearance | Light brown to brown | Light brown to brown |
| | flowing granules, free | flowing granules, free |
| | from extraneous matter | from extraneous matter |
| Chlorantraniliprole | 0.464 | 0.478 |
| content | | |
| Cartap content | 7.58 | 7.66 |
| pH (1% Aq. Dispersion) | 0.41 | 0.36 |
| Moisture (% w/w) | 3.47 | 4.2 |
| Particles pass through | 99.5 | 99.5 |
| sieve of 12 BSS | | |
| Particles pass through | 0.05 | 0.05 |
| sieve of 36 BSS | | |

Example-3

| | | |
|---|---|---|
| Appearance | Brown color | Brown color |
| | sand granules | sand granules |
| Chlorantraniliprole | 0.529 | 0.526 |
| content | | |
| Flupyrimin content | 1.065 | 1.065 |
| pH (1% Aq. Dispersion)* | 6.70 | 6.79 |

TABLE 15
Example 3

| Test Parameters | 0 day Results | 14 Days 54° C. AHS |
|---|---|---|
| Appearance | Brown color | Brown color |
| | sand granules | sand granules |
| Chlorantraniliprole content | 0.529 | 0.526 |
| Flupyrimin content | 1.065 | 1.065 |
| pH (1% Aq. Dispersion)* | 6.70 | 6.79 |

TABLE 16
Example-4

| Test Parameters | 0 day Results | 14 Days 54° C. AHS |
|---|---|---|
| Appearance | Light brown to brown | Light brown to brown |
| | flowing granules, free | flowing granules, free |
| | from extraneous matter | from extraneous matter |
| Chlorantraniliprole | 0.43 | 0.42 |
| content | | |
| Fipronil content | 0.44 | 0.4 |
| pH (1% Aq. Dispersion)* | 7.53 | 7.48 |
| Moisture (% w/w) | 0.53 | 0.48 |
| Particles pass through | 99 | 99 |
| sieve of 12 BSS | | |
| Particles pass through | 1 | 1 |
| sieve of 36 BS | | |

TABLE 17
Example-5

| Test Parameters | 0 day Results | 14 Days 54° C. AHS |
|---|---|---|
| Appearance | Blue color | Blue color |
| | granules | granules |
| Active as | 0.443 | 0.423 |
| Chlorantraniliprole (% w/w) | | |
| Active as Novaluron (% w/w) | 0.93 | 0.942 |
| pH (1% aq. Dispersion) | 6.5 | 6.54 |

TABLE 18
Example-6

| Test Parameters | 0 day Results | 14 Days 54° C. AHS |
|---|---|---|
| Appearance | Light brown to | Light brown to |
| | brown flowing | brown flowing |
| | granule | granule |
| Active as | 0.416 | 0.416 |
| Chlorantraniliprole (% w/w) | | |
| pH (1% aq. Dispersion) | 8.39 | 8.21 |

TABLE 19
Example 7

| Test Parameters | 0 day Results | 14 Days 54° C. AHS |
|---|---|---|
| Appearance | Brown color | Brown color |
| | sand granules | sand granules |
| Active as | 0.594 | 0.589 |
| Chlorantraniliprole(% w/w) | | |
| Active as Flupyrimin (% w/w) | 1.19 | 1.176 |
| pH (1% aq. Dispersion) | 7.91 | 7.82 |

TABLE 20
Example 8

| Test Parameters | 0 day Results | 14 Days 54° C. AHS |
|---|---|---|
| Appearance | Brown color | Brown color |
| | sand granules | sand granules |
| Active as | 0.502 | 0.503 |
| Chlorantraniliprole (% w/w) | | |
| Active as Flupyrimin (% w/w) | 1.056 | 1.031 |
| pH (1% aq. Dispersion) | 7.75 | 7.40 |

TABLE 21
Example 9

| Test Parameters | 0 day Results | 14 Days 54° C. AHS |
|---|---|---|
| Appearance | Brown color | Brown color |
| | sand granules | sand granules |
| Active as | 0.532 | 0.514 |
| Chlorantraniliprole (% w/w) | | |
| Active as Flupyrimin (% w/w) | 1.11 | 1.087 |
| pH (1% aq. Dispersion) | 6.73 | 6.95 |

TABLE 22
Example 10

| Test Parameters | 0 day Results | 14 Days 54° C. AHS |
|---|---|---|
| Appearance | Brown color | Brown color |
| | sand granules | sand granules |
| Active as | 0.444 | 0.443 |
| Chlorantraniliprole (% w/w) | | |
| Active as Flupyrimin(% w/w) | 1.06 | 1.059 |
| pH (1% aq. Dispersion) | 6.37 | 6.42 |

TABLE 23

| | | |
|---|---|---|
| Test Parameters | 0 day Results | 14 Days 54° C. AHS |

Example 11

| | | |
|---|---|---|
| Appearance | Brown color | Brown color |
| | sand granules | sand granules |
| Active as | 0.405 | 0.407 |
| Chlorantraniliprole (% w/w) | | |
| Active as Flupyrimin (% w/w) | 1.05 | 1.044 |
| pH (1% aq. Dispersion) | 6.58 | 6.65 |

Example-12

| | | |
|---|---|---|
| Appearance | Blue color | Blue color |
| | granules | granules |
| Active as | 0.494 | 0.488 |
| Chlorantraniliprole (% w/w) | | |
| pH (1% aq. Dispersion) | 8.39 | 8.09 |

Release Rate study of Quick Release Compositions

The quick release compositions of Examples 1-3 and 12, were studied to assess the release rate of chlorantraniliprole (CTPR) and other insecticidally active ingredients. The release rate was determined using a tablet disintegration apparatus comprised of a sample dipping tube (glass disintegration tube) and a dipping tub. Specifically, 2.5 g composition of Example 1 was contained in a glass disintegration tube modified by sealing the sides with a 425-micron sieve. The glass disintegration tube was set to be dipped in the tub at a constant speed of 30 dips/min (minute) such that the granular composition released active ingredient with each dip. A portion of the contents of the tub was withdrawn from the apparatus at various points in time (1 min, 3 min, 5 min and 10 min) and the amount of active ingredients present was analysed. Similarly, the compositions of Examples 2, 3 and 12 were also analysed to estimate the release rate of active ingredients.

It was found that the compositions of Examples 1-3 and 12 released greater than 83% active ingredients within 10 min. For comparison, the commercial sample of 0.4% chlorantraniliprole GR was also analysed in the same disintegration apparatus to analyse the rate of release, which was about 38% release of active ingredient (AI) in 10 min. Therefore, quick release compositions developed according to the present disclosure successfully demonstrated quick release of active ingredients from the carrier granules. (Table 24)

TABLE 24

| | | Release rate (%) | | | | |
|---|---|---|---|---|---|---|
| Product | AI | 0 min | 1 min | 3 min | 5 min | 10 min |
| CTPR 0.4% GR | CTPR | 0.00 | 17.80 | 31.22 | 30.24 | 38.05 |
| (Marketed Product) | | | | | | |
| Example 1 | CTPR | 0.00 | 95.24 | 98.90 | 99.63 | 99.39 |
| CTPR 0.8% + | Fipronil | 0.00 | 95.41 | 99.77 | 99.77 | 99.17 |
| Fipronil 1.33% GR | | | | | | |
| Example 2 | CTPR | 0.00 | 86.40 | 91.80 | 92.30 | 93.20 |
| CTPR 0.4% + | Cartap HCL | 0.00 | 89.00 | 94.30 | 98.00 | 100.00 |
| Cartap HCL 7% GR | | | | | | |
| Example 3 | CTPR | 0.00 | 35.19 | 68.46 | 81.73 | 87.69 |
| CTPR | Flupyrimin | 0.00 | 41.43 | 78.19 | 90.10 | 95.81 |
| 0.5% + Flupyrimin | | | | | | |
| 1% GR | | | | | | |
| Example 12 | CTPR | 0.00 | 17.70 | 65.30 | 76.20 | 83.30 |
| CTPR 0.4% GR | | | | | | |

The quick release insecticidal compositions comprising diamide insecticide disclosed herein result in stable insecticidal compositions. The carrier matrix comprising a binder and a surfactant successfully provided integrity to the quick release insecticidal composition by holding the active ingredients and inert ingredients together, and upon application, the compositions provided quick release of active ingredients. The careful selection of the binder and surfactant in a specific ratio range from about 1:5 to about 5:1 in formulating quick release composition provided excellent stability over time and at various temperatures.

1. A quick release insecticidal composition comprising:
at least one diamide insecticide; and
a carrier matrix comprising a binder and a surfactant, wherein the diamide insecticide is dispersed in the carrier matrix.

2. The quick release insecticidal composition of claim 1, wherein the ratio of binder to surfactant in the carrier matrix is from about 1:5 to about 5:1.

3. The quick release insecticidal composition of claim 1, further comprising a carrier granule, and wherein the composition comprising the diamide insecticide and the carrier matrix is coated on a surface of the carrier granule.

4. The quick release insecticidal composition of claim 3, wherein the carrier granule comprises sand, silica, bentonite, attapulgite, ceramic, montmorillonite, pumice, sepiolite, diatomaceous earth, clay, dolomite, calcite, or a combination thereof.

5. The composition of claim 1, wherein the diamide insecticide comprises afoxolaner, broflanilide, chlorantraniliprole, cyantraniliprole, cyclaniliprole, cyhalodiamide, flubendiamide, fluralaner, lotilaner, tetrachlorantraniliprole, tetraniliprole, or a combination thereof.

6. The composition of claim 1, wherein the diamide insecticide is chlorantraniliprole.

7. The composition of claim 1, wherein the diamide insecticide is cyantraniliprole.

8. The composition of claim 1, wherein the binder is a water-soluble binder, a water-swellable binder, or a combination thereof.

9. The composition of claim 7, wherein the binder is a water-soluble binder comprising polyvinyl pyrrolidone, polyethylene glycol, polyethylene oxide, polyethoxylated fatty acids, polyethoxylated alcohols, a natural gum, lignosulphonate, or a combination thereof.

10. The composition of claim 1, wherein the binder is a water swellable binder comprising china clay, bentonite, fuller's earth, zeolite, quartz, precipitated silica, palygorskite, sepiolite, halloysite, or a combination thereof.

11. The composition of claim 1, wherein the surfactant comprises an anionic surfactant, a cationic surfactant, a non-ionic surfactant, an amphoteric surfactant, or a combination thereof.

12. The composition of claim 1, further comprising at least one additional insecticide.

13. A quick release insecticidal granule comprising:
at least one diamide insecticide;
a carrier matrix comprising a binder and a surfactant; and
a carrier granule;
wherein the diamide insecticide is dispersed in the carrier matrix;
and wherein the diamide insecticide and the carrier matrix are coated on a surface of the carrier granule.

14. A process of preparing a quick release insecticidal granule, comprising:
mixing at least one diamide insecticide and a carrier matrix comprising a binder and a surfactant to obtain a pre-mix;
coating the pre-mix on a carrier granule to obtain a coated granule; and
drying the coated granule to provide the quick release insecticidal granule.

15. A method of controlling pests comprising applying a quick release insecticidal composition to a pest or to a locus comprising the pest, wherein the quick release insecticidal composition comprises:
at least one diamide insecticide;
a carrier matrix comprising a binder and a surfactant; and
a carrier granule,
wherein the diamide insecticide is dispersed in the carrier matrix, and the diamide insecticide and the carrier matrix are coated on a surface of the carrier granule.
